(19) United States
(12) Patent Application Publication
(10) Pub. No.: US 2025/0100097 A1
(43) Pub. Date: Mar. 27, 2025

(54) MOTOR CONTROL DEVICE, MACHINING SYSTEM, MOTOR CONTROL METHOD, AND MACHINING METHOD

(71) Applicant: Mitsubishi Electric Corporation, Tokyo (JP)

(72) Inventors: Yunosuke OMOTO, Tokyo (JP); Shinya NISHINO, Tokyo (JP)

(73) Assignee: Mitsubishi Electric Corporation, Tokyo (JP)

(21) Appl. No.: 18/730,821

(22) PCT Filed: Jan. 31, 2022
(86) PCT No.: PCT/JP2022/003590

§ 371 Date: Jul. 22, 2024

(51) Int. Cl. B23Q 15/08; B23Q 5/10

(52) U.S. Cl. CPC B23Q 15/08; B23Q 5/10

(57) ABSTRACT

A motor control device that generates, based on acceleration time constant and deceleration time constant, a control signal for a motor driving a drive shaft includes a synchronous operation command extraction unit extracting, from within a machining program, blocks where set-point control is continuously commanded for the drive shafts that synchronize and extracting synchronous operation commands included in the blocks; an operation state computation unit computing, based on acceleration time constant and deceleration time constant, operation time and consumption energy associated with machining performed with the machining program; an optimum parameter computation unit computing, for each synchronous operation command, the acceleration time constant and the deceleration time constant that result in the operation time of the drive shaft being within allowable operation time for operation and the consumption energy being minimum as optimum parameters; and a motor control unit generating the control signal based on the optimum parameters.

### FIELD

The present disclosure relates to a motor control device that controls motors and also relates to a machining system, a motor control method, and a machining method.

### BACKGROUND

A motor control device is a device that controls a spindle motor, which rotates a tool or a workpiece, and feed shaft motors, which move the tool or the workpiece, thus causing a numerically controlled machine tool to machine the workpiece. This motor control device uses converters and inverters to control the motors, such as the spindle motor and the feed shaft motors. Total consumption energy of a drive system that includes the converters, the inverters, and the motors can be expressed as the sum of motor outputs and losses in the converters, the inverters, and the motors. In this case, conduction losses and switching losses of converter diodes included in the converters, conduction losses and switching losses of inverter diodes included in the inverters, and copper losses in the servomotors decrease as motor driving currents decrease. However, reducing the motor driving currents generally has a trade-off relationship with reducing acceleration time and deceleration time. Therefore, setting smaller driving currents results in an extended cycle time.

A control device described in Patent Literature 1 computes, using consumption energy and cycle time as indicators, a parameter set that is used in setting operation command patterns for motors and executes a machining program on the basis of the computed parameter set, thus reducing consumption energy.

### CITATION LIST

### Patent Literature

Patent Literature 1: Japanese Patent Application Laid-open No. 2010-240800

### SUMMARY OF INVENTION

### Problem to be solved by the Invention

However, a problem with the above technique described in Patent Literature 1 is that consumption energy cannot be reduced for an operation other than machining, such as a tool change, because the single parameter set is set for the entire machining program.

The present disclosure has been made in view of the above, and an object of the present disclosure is to obtain a motor control device capable of setting, for an operation other than machining, parameters that allow for a shorter cycle time and reduced consumption energy.

### Means to Solve the Problem

In order to solve the above-stated problem and achieve the object, a motor control device according to the present disclosure generates, on the basis of an acceleration time constant that defines an acceleration time of a drive shaft and a deceleration time constant that defines a deceleration time of the drive shaft, a control signal for a motor that drives the drive shaft. The motor control device includes a synchronous operation command extraction unit that extracts, from within a machining program, blocks where set-point control is to be continuously commanded for a plurality of the drive shafts that synchronize and extracts synchronous operation commands included in the blocks. Furthermore, the motor control device according to the present disclosure includes an operation state computation unit that computes, on the basis of an acceleration time constant and a deceleration time constant, an operation time and consumption energy that are associated with machining to be performed with the machining program. Furthermore, the motor control device according to the present disclosure includes an optimum parameter computation unit that computes, for each of the synchronous operation commands, the acceleration time constant and the deceleration time constant that result in the operation time of the drive shaft being within an allowable operation time representing an allowable time for operation and the consumption energy being minimum as optimum parameters; and a motor control unit that generates the control signal for the motor on the basis of the optimum parameters.

### Effects of the Invention The motor control device according to the present

disclosure has an effect of setting, for an operation other than machining, parameters that allow for a shorter cycle time and reduced consumption energy.

### BRIEF DESCRIPTION OF DRAWINGS

FIG. 1 is a functional block diagram of a motor control device according to a first embodiment.

FIG. 2 is a diagram that is used for explaining synchronous operation commands extracted by the motor control device according to the first embodiment.

FIG. 3 is a diagram illustrating an example of a command pattern for a drive shaft that is used by the motor control device according to the first embodiment.

FIG. 4 is a diagram that is used for explaining operation states computed for a feed shaft by the motor control device according to the first embodiment.

FIG. 5 is a diagram that is used for explaining operation states computed for a spindle by the motor control device according to the first embodiment.

FIG. 6 is a diagram illustrating a configuration example of an operation state table that the motor control device according to the first embodiment stores.

FIG. 7 is a flowchart illustrating a procedure of a process that is performed by an operation state computation unit of the motor control device according to the first embodiment.

FIG. 8 is a diagram that is used for explaining a process by which the motor control device according to the first embodiment extracts combinations of acceleration time constants and deceleration time constants on the basis of an allowable operation time.

FIG. 9 is a diagram that is used for explaining a process by which the motor control device according to the first embodiment extracts a combination of an acceleration time constant and a deceleration time constant on the basis of consumption energy.

FIG. 10 is a diagram illustrating operation time resulting from surface approximation performed by the motor control device according to the first embodiment.

FIG. 11 is a diagram illustrating consumption energy resulting from the surface approximation performed by the motor control device according to the first embodiment.

FIG. 12 is a flowchart illustrating a procedure of a process that is performed by an optimum parameter computation unit of the motor control device according to the first embodiment.

FIG. 13 is a diagram illustrating first example command patterns using optimum parameters computed by the motor control device according to the first embodiment.

FIG. 14 is a diagram illustrating first example power waveforms that result from the use of the optimum parameters computed by the motor control device according to the first embodiment.

FIG. 15 is a diagram illustrating second example command patterns using optimum parameters computed by the motor control device according to the first embodiment.

FIG. 16 is a diagram illustrating second example power waveforms that result from the use of the optimum parameters computed by the motor control device according to the first embodiment.

FIG. 17 is a flowchart illustrating a procedure of a process that is performed by the motor control device according to the first embodiment.

FIG. 18 is a functional block diagram of a motor control device according to a second embodiment.

FIG. 19 is a diagram illustrating first example power waveforms that result from use of optimum parameters computed, with a range for total power values taken into consideration, by the motor control device according to the second embodiment.

FIG. 20 is a diagram illustrating second example power waveforms that result from use of optimum parameters computed, with the range for total power values taken into consideration, by the motor control device according to the second embodiment.

FIG. 21 is a functional block diagram of a machining system according to a third embodiment.

FIG. 22 is a flowchart illustrating a procedure of a process that is performed by the machining system according to the third embodiment.

FIG. 23 is a diagram illustrating a configuration example of processing circuitry implemented with a processor and a memory as processing circuitry of the motor control device according to each of the first through third embodiments.

FIG. 24 is a diagram illustrating an example of processing circuitry configured as dedicated hardware to serve as the processing circuitry of the motor control device according to each of the first through third embodiments.

### DESCRIPTION OF EMBODIMENTS

With reference to the drawings, a detailed description is hereinafter provided of motor control devices, machining systems, motor control methods, and machining methods according to embodiments of the present disclosure.

### First Embodiment

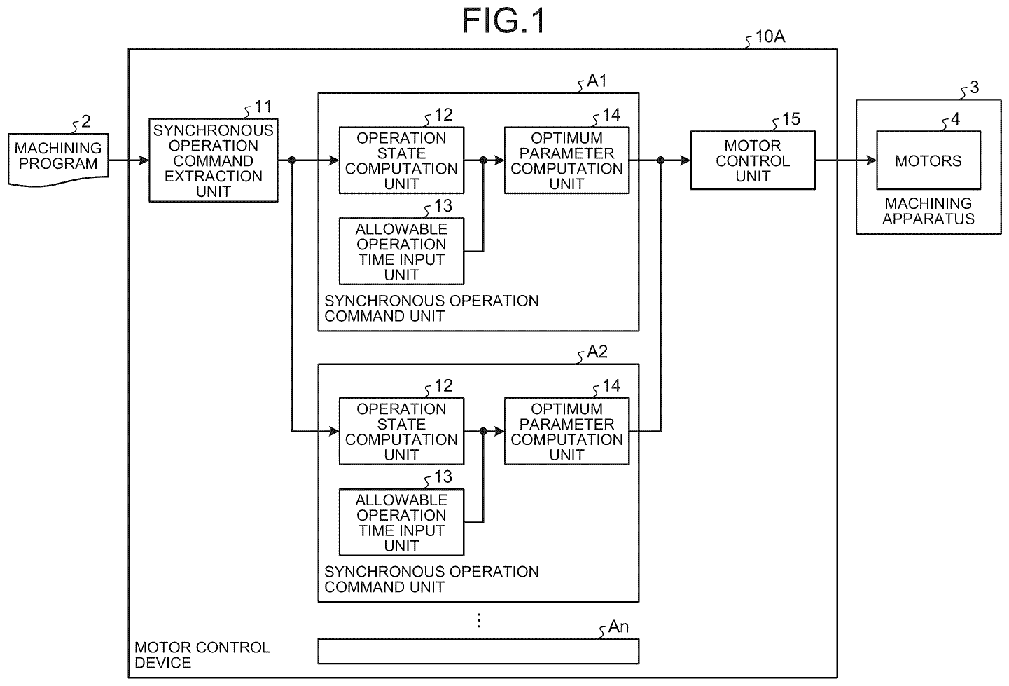

FIG. 1 is a functional block diagram of a motor control device according to a first embodiment. The motor control device 10A is a computer that controls a machining apparatus 3 including motors 4. On the basis of a machining program 2 created by a computer-aided manufacturing (CAM) system or the like, the motor control device 10A generates and outputs control signals for the motors 4 that drive drive shafts.

The machining apparatus 3 machines a workpiece (work material) to be machined by operating the motors 4 in accordance with the control signals for the motors 4. The machining apparatus 3 is, for example, a machine tool disposed in a production facility. The motor control device 10A includes a numerical control device to perform numerical control of the machining apparatus 3. The drive shafts that are driven by the motors 4 include, for example, a spindle, feed shafts, and rotating shafts, among others. In the first embodiment, the machining apparatus 3 is described as having the spindle and the feed shafts.

The spindle is a shaft with which a tool or the workpiece is rotated. The feed shafts include feed shafts (described later as tool feed shafts) with which the tool is moved and a feed shaft (described later as a workpiece feed shaft) with which the workpiece is moved,

The motor control device 10A may be disposed near the machining apparatus 3 or installed on a server or the like that is away from the machining apparatus 3. The motor control device 10A includes a synchronous operation command extraction unit 11, one or more synchronous operation command units, and a motor control unit 15. The motor control device 10A illustrated in FIG. 1 includes synchronous operation command units A1 to An (where n is a natural number) as the synchronous operation command units. The motor control device 10A is described below as having synchronous operation command units A1 and A2 as the synchronous operation command units.

For each of synchronous operation commands, each of the synchronous operation command units A1 and A2 computes optimum parameters and sends the computed optimum parameters to the motor control unit 15. When there are more synchronous operation commands than the synchronous operation command units, the synchronous operation command units share optimum parameter computations for the synchronous operation commands. In other words, the synchronous operation command unit that has completed the optimum parameter computation performs the optimum parameter computation on an unprocessed synchronous operation command. In the motor control device 10A, such a process is repeated by the synchronous operation command units.

Each of the synchronous operation command units A1 and A2 includes an operation state computation unit 12, an allowable operation time input unit 13, and an optimum parameter computation unit 14. The synchronous operation command extraction unit 11 is connected to the operation state computation units 12 of the synchronous operation command units A1 and A2. The motor control unit 15 is connected to the optimum parameter computation units 14 of the synchronous operation command units A1 and A2.

In each of the synchronous operation command units A1 and A2, the operation state computation unit 12 and the allowable operation time input unit 13 are connected to the optimum parameter computation unit 14.

The machining program 2 created by the CAM system or the like is input to the synchronous operation command extraction unit 11. The synchronous operation command extraction unit 11 receives the machining program 2. The synchronous operation command extraction unit 11 analyzes the input machining program 2 and extracts, from among blocks (plural blocks constituting a series of commands) included in the machining program 2, blocks (a group including a set of synchronous operation commands) where set-point control is to be continuously commanded for two or more of the drive shafts that synchronize. Furthermore, the synchronous operation command extraction unit 11 extracts the synchronous operation commands included in the extracted blocks. The set-point control refers to control that brings a controlled variable close to a set point.

The synchronous operation command extraction unit 11 judges that positioning commands for the feed shafts (the tool feed shafts in the first embodiment) and a constant-speed rotation command for the spindle are for the set-point control, thus extracting the synchronous operation commands. In other words, commands extracted as synchronous operation commands in the first embodiment are a combination of positioning commands for the tool feed shafts and a constant-speed rotation command for the spindle that is to undergo the set-point control. In cases where the machining apparatus 3 includes the rotating shafts, positioning commands for the rotating shafts, if included in synchronous operation commands, are extracted as synchronous operation commands by the synchronous operation command extraction unit 11.

On the basis of M-code commands, the synchronous operation command extraction unit 11 extracts, from within the machining program 2, a movement block for movement to a tool change position before a tool change and a movement block for movement to a next machining position after the tool change as synchronous operation commands. In other words, the synchronous operation command extraction unit 11 extracts the movement block (first movement block) for the movement from a machining end position, where machining before the tool change ends, to the tool change position, where the tool change is performed, as the synchronous operation command. The synchronous operation command extraction unit 11 extracts the movement block (second movement block) for the movement from a tool change end position, where the tool change ends, to the machining start position, where machining is performed next after the tool change, as the synchronous operation command, For example, the synchronous operation command extraction unit 11 extracts at least one of the first movement block or the second movement block as the synchronous operation command(s).

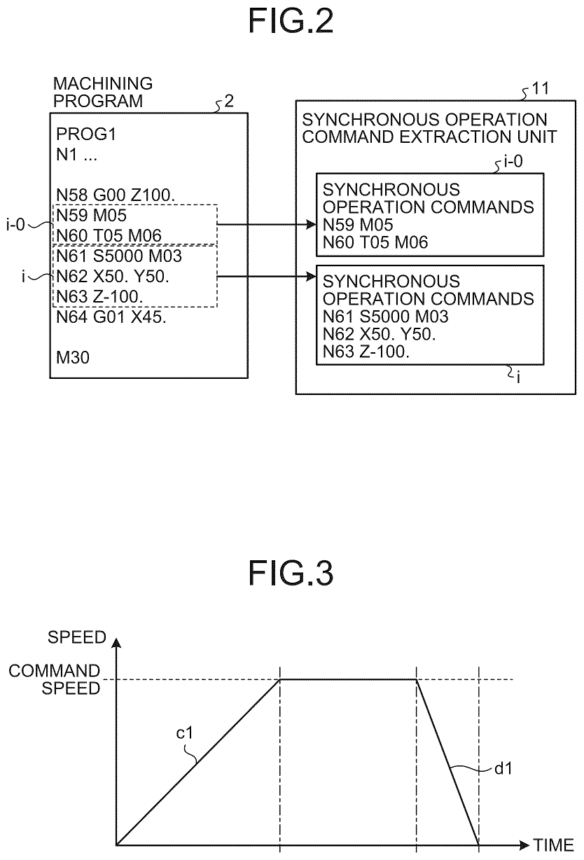

A description is provided here of synchronous operation commands that are extracted by the synchronous operation command extraction unit 11 of the motor control device 10A. FIG. 2 is a diagram that is used for explaining the synchronous operation commands extracted by the motor control device according to the first embodiment. FIG. 2 illustrates an example of the machining program 2 and a result of a synchronous operation command extraction process performed by the synchronous operation command extraction unit 11.

The machining program 2 includes plural lines of alphanumeric characters, with each of the lines indicating a command for the machining apparatus 3. Those alphanumeric characters at a left end of the machining program 2 in FIG. 2 are sequence numbers of the machining program 2. For example, the machining program 2 includes commands with sequence numbers N58 to N64.

The command at N59 represents a spindle stop command, and the command at N60 represents a tool change command. Specifically, the command at N59 and the command at N60 are synchronous operation commands (i-0) for moving the spindle to a tool change position while decelerating the spindle. Therefore, the synchronous operation command extraction unit 11 extracts the command at N59 and the command at N60 in the machining program 2 as the synchronous operation commands (i-0).

The commands at N61 to N63 in the machining program 2 represent spindle positive rotation, X-and Y-axes positioning, and Z-axis positioning, respectively. Specifically, the commands at N61 to N63 are synchronous operation commands (i) for moving the spindle to a machining start position while accelerating the spindle. Therefore, the synchronous operation command extraction unit 11 extracts the commands at N61 to N63 in the machining program 2 as the synchronous operation commands (1).

Each operation state computation unit 12 computes operation states for the drive shaft. The operation state computation unit 12 computes the operation states based on plural preset acceleration time constants and plural preset deceleration time constants. The acceleration time constant is a time constant that defines an acceleration time of the drive shaft, and the deceleration time constant is a time constant that defines a deceleration time of the drive shaft. The acceleration time constant is expressed as a time that is taken from when acceleration starts to when a command speed as a target is reached, and the deceleration time constant is expressed as a time that is taken from when deceleration starts to when a speed of 0 is reached. The acceleration time constants and the deceleration time constants that are preset may be uniform or vary among the drive shafts. The acceleration time constants and the deceleration time constants are preset externally by a user in each operation state computation unit 12.

A description is provided here of an example of a command pattern for the drive shaft that is used by the motor control device 10A. FIG. 3 is a diagram illustrating the example command pattern for the drive shaft that is used by the motor control device according to the first embodiment. A graph illustrated in FIG. 3 depicts time on a horizontal axis and speed on a vertical axis.

FIG. 3 is the diagram schematically illustrating the command pattern for the drive shaft. As illustrated in FIG. 3, the command pattern is determined by a command speed specified in the machining program 2, an acceleration time constant c1 that is set, and a deceleration time constant dl that is set. The drive shaft is to accelerate or gain speed in accordance with the acceleration time constant c1 until reaching the command speed specified in the machining program 2 and is to be driven at this command speed. Subsequently, the drive shaft is to decelerate in accordance with the deceleration time constant di and stops.

On the basis of each command pattern, the operation state computation unit 12 computes an operation time and consumption energy for the drive shaft as operation states. The operation state computation unit 12 may also compute a power waveform for the drive shaft as an operation state in addition to the operation time and the consumption energy.

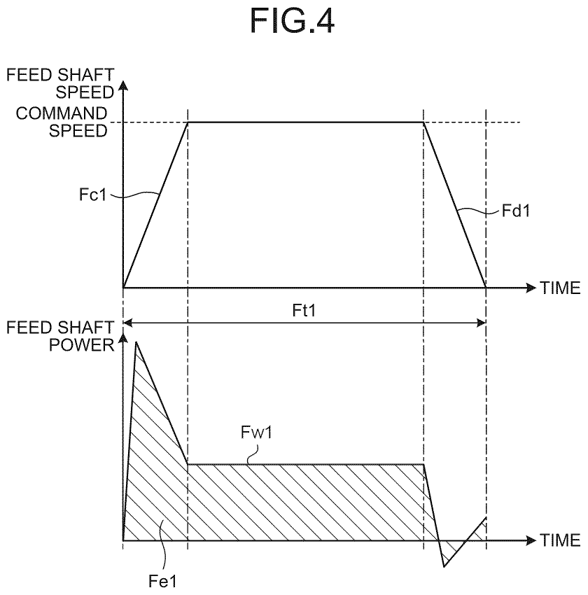

FIG. 4 is a diagram that is used for explaining operation states computed for the feed shaft by the motor control device according to the first embodiment. FIG. 4 is the diagram schematically illustrating the operation states computed for the feed shaft by the operation state computation unit 12. A graph illustrated in an upper part of FIG. 4 depicts time on a horizontal axis and speed of the feed shaft (feed shaft speed) on a vertical axis. A graph illustrated in a lower part of FIG. 4 depicts time on a horizontal axis and power for the feed shaft (feed shaft power) on a vertical axis.

A feed shaft operation time Ft1, an operation time of the feed shaft, is a time that is to be taken from when output of a positioning command starts to when the positioning is completed. The feed shaft is to accelerate or gain speed in accordance with a feed shaft acceleration time constant Fc1 that is an acceleration time constant for the feed shaft until reaching a command speed specified in the machining program 2 and is to be driven at this command speed. Subsequently, the feed shaft is to decelerate in accordance with a feed shaft deceleration time constant Fd1 that is a deceleration time constant for the feed shaft and stop.

A feed shaft power waveform Fw1, a power waveform of the feed shaft, is a collection of power values sampled within the operation time of the feed shaft. Feed shaft consumption energy Fe1, consumption energy of the feed shaft, is an integral value of power sampled within the operation time of the feed shaft.

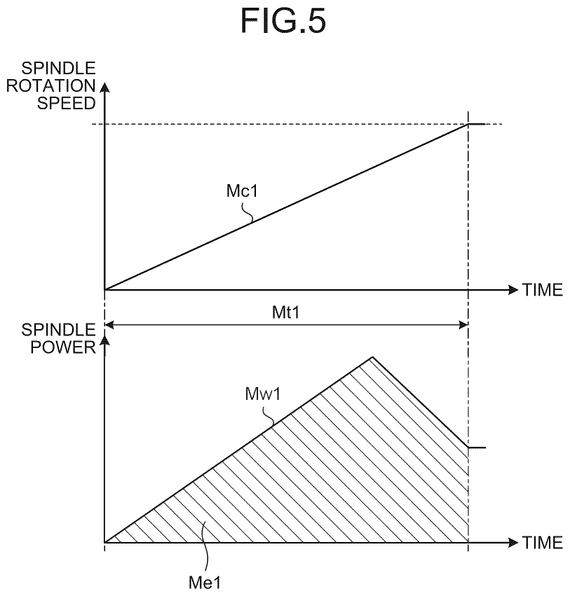

FIG. 5 is a diagram that is used for explaining operation states computed for the spindle by the motor control device according to the first embodiment. FIG. 5 is the diagram schematically illustrating the operation states computed for the spindle by the operation state computation unit 12. A graph illustrated in an upper part of FIG. 5 depicts time on a horizontal axis and rotation speed of the spindle (spindle rotation speed) on a vertical axis. A graph illustrated in a lower part of FIG. 5 depicts time on a horizontal axis and power for the spindle (spindle power) on a vertical axis.

A spindle operation time Mt1, an operation time of the spindle, is a time that is to be taken from when output of a rotation command starts to when the rotation speed of the spindle reaches a command rotation speed. The spindle rotation speed is to increase in accordance with a spindle acceleration time constant Mc1 that is an acceleration time constant for the spindle.

A spindle power waveform Mw1, a power waveform of the spindle, is a collection of power values sampled within the operation time of the spindle. Spindle consumption energy Me1, consumption energy of the spindle, is an integral value of power sampled within the operation time of the spindle.

The operation state computation unit 12 computes operation states by simulation using a command pattern and a simulation model of a system including the motors 4 and the drive shafts. The operation state computation unit 12 may compute operation states, using a machine learning model generated from accumulated data of previously computed operation states. The operation state computation unit 12 may compute operation states by measuring an operation time with a timer and measuring a power waveform and consumption energy with a power meter.

The operation state computation unit 12 stores, in an operation state table to be described later, the computed operation states along with the acceleration and deceleration time constants used in the computation. The operation state computation unit 12 includes a memory (not illustrated) or the like that stores the operation state table. The memory that stores the operation state table may be disposed externally to the operation state computation unit 12.

For each of the drive shafts, a minimum value, a maximum value, and increments of each of the acceleration and deceleration time constants are predetermined in each operation state computation unit 12. In the operation state table, a total number of combinations of the acceleration time constants and the deceleration time constants corresponds to a table count. Each operation state computation unit 12 may prepare an operation state table where increments of the acceleration time constant and increments of the deceleration time constant are not uniform and store computed operation states in the operation state table.

The acceleration time constants and the deceleration time constants in the operation state table are set by the user. The user may set the minimum values, the maximum values, and the increments of the acceleration and deceleration time constants in the operation state computation units 12 or set acceleration and deceleration time constants in nonuniform increments in the operation state computation units 12.

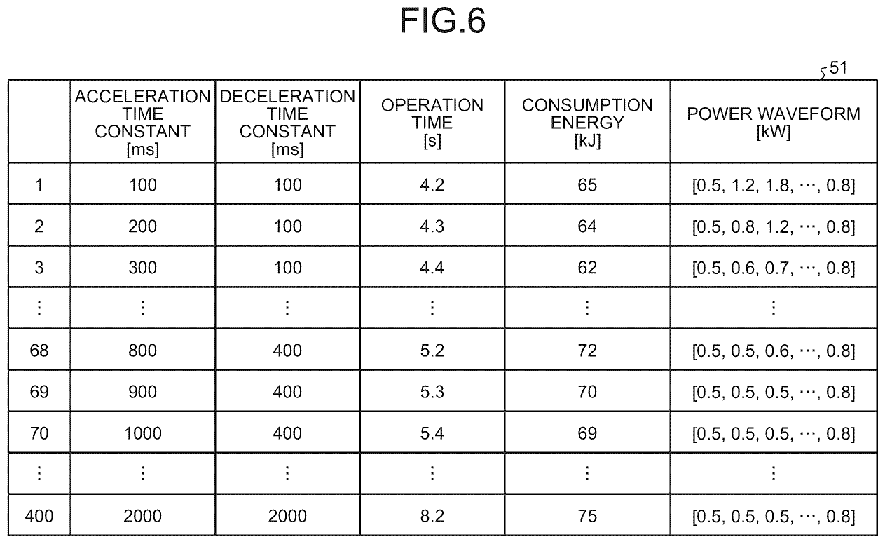

FIG. 6 is a diagram illustrating a configuration example of the operation state table that the motor control device according to the first embodiment stores. FIG. 6 illustrates the example of the operation state table 51 that includes operation states stored by the operation state computation unit 12.

The operation state table 51 is a drive shaft-specific table where the acceleration time constant, the deceleration time constant, the operation time, the consumption energy, and the power waveform are associated. For the power waveform, sampled power values sampled at specific intervals within the operation time of the drive shaft are stored.

In FIG. 6, the minimum value, the maximum value, and every increment of each of the acceleration and deceleration time constants are respectively 100, 2000, and 100, with the total number of combinations of the acceleration time constants and the deceleration time constants being 400.

For each of the combinations of the acceleration time constants and the deceleration time constants stored in the operation state table 51, the operation state computation unit 12 computes the operation time, the consumption energy, and the power waveform as the operation states and stores these computation results in the operation state table 51. The operation state computation unit 12 generates the operation state table 51, such as illustrated in FIG. 6, for each synchronous operation command included in the set (for each block).

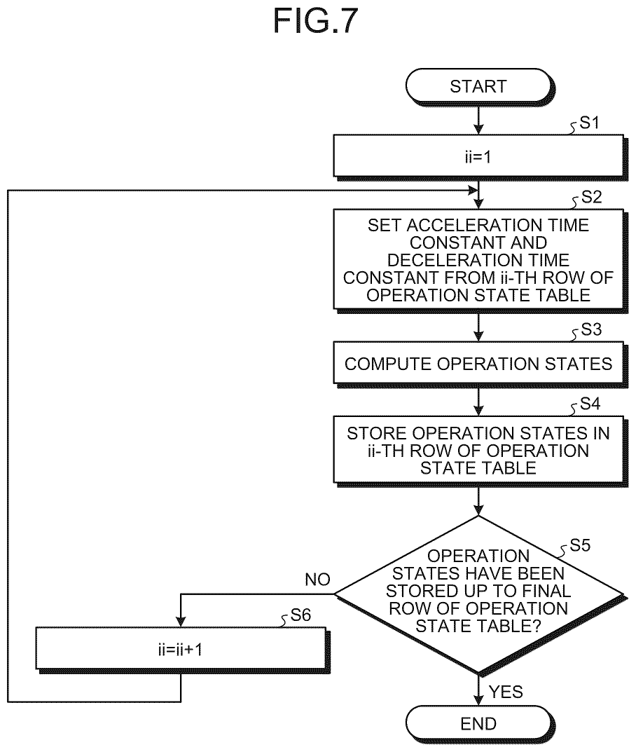

A description is provided here of a procedure of a process by which the operation state computation unit 12 generates the operation state table 51. FIG. 7 is a flowchart illustrating the procedure of the process that is performed by the operation state computation unit of the motor control device according to the first embodiment. FIG. 7 illustrates an example flow of an operation sequence of the operation state computation unit 12. The operation state computation unit 12 performs the process illustrated in FIG. 7 for each synchronous operation command included in the set (for each block).

The operation state computation unit 12 sets ii that indicates a row number in the operation state table 51 to 1 (step S1). The operation state computation unit 12 sets the acceleration time constant and the deceleration time constant from a ii-th row of the operation state table 51 (step S2) and computes the operation states, using the set acceleration and deceleration time constants (step S3).

The operation state computation unit 12 stores the computed operation states in the ii-th row of the operation state table 51 (step S4). The operation state computation unit 12 determines whether or not the operation states have been stored up to a final row of the operation state table 51 (step S5).

If the operation state computation unit 12 determines that the operation states have not been stored up to the final row of the operation state table 51 (step S5, No), the operation state computation unit 12 sets ii to ii+1 (step S6). The operation state computation unit 12 then performs the operations of steps S2 to S5.

The operation state computation unit 12 repeats the operation of step S6 and the operations of steps S2 to S5 until the operation state computation unit 12 determines that the operation states have been stored up to the final row of the operation state table 51.

If the operation state computation unit 12 determines that the operation states have been stored up to the final row of the operation state table 51 (step S5, Yes), the operation state computation unit 12 ends the process of generating the operation state table 51. The operation state computation unit 12 may compute and store the operation states for each row of the operation state table 51 in any order.

The operation state computation unit 12 stores the operation state table 51 where the operation states have been stored up to the final row. The operation state computation unit 12 sends the operation state table 51 where the operation states have been stored up to the final row to the optimum parameter computation unit 14.

The allowable operation time input unit 13 stores a buffer time for the operation time and inputs the stored buffer time to the optimum parameter computation unit 14. A minimum one of the operation times computed by the operation state computation unit 12 plus the buffer time input from the allowable operation time input unit 13 is an allowable operation time. This allowable operation time may be computed and input to the optimum parameter computation unit 14 by the allowable operation time input unit 13 or may be computed by the optimum parameter computation unit 14.

In cases where the allowable operation time input unit 13 computes the allowable operation time, the allowable operation time input unit 13 computes the sum of the minimum operation time computed by the operation state computation unit 12 and the buffer time as the allowable operation time and inputs the computed allowable operation time to the optimum parameter computation unit 14.

In cases where the optimum parameter computation unit 14 computes the allowable operation time, the optimum parameter computation unit 14 computes the sum of the minimum operation time computed by the operation state computation unit 12 and the buffer time input from the allowable operation time input unit 13 as the allowable operation time.

The allowable operation time input unit 13 may input an externally input allowable operation time to the optimum parameter computation unit 14. The externally input allowable operation time is longer than the minimum operation time computed by the operation state computation unit 12.

For each synchronous operation command, the optimum parameter computation unit 14 computes, on the basis of the operation state table 51 generated by the operation state computation unit 12, an acceleration time constant optimum for the drive shaft (hereinafter referred to as an optimum acceleration time constant) and a deceleration time constant optimum for the drive shaft (hereinafter referred to as an optimum deceleration time constant) as optimum parameters. The optimum parameter computation unit 14 computes the combination of the constant that results in the consumption energy being minimum in a range where the operation time falls within the allowable operation time as the combination of the optimum acceleration time constant and the optimum deceleration time constant. In the first embodiment, the optimum acceleration time constant and the optimum deceleration time constant that are computed in combination by the optimum parameter computation unit 14 are defined as the optimum parameters.

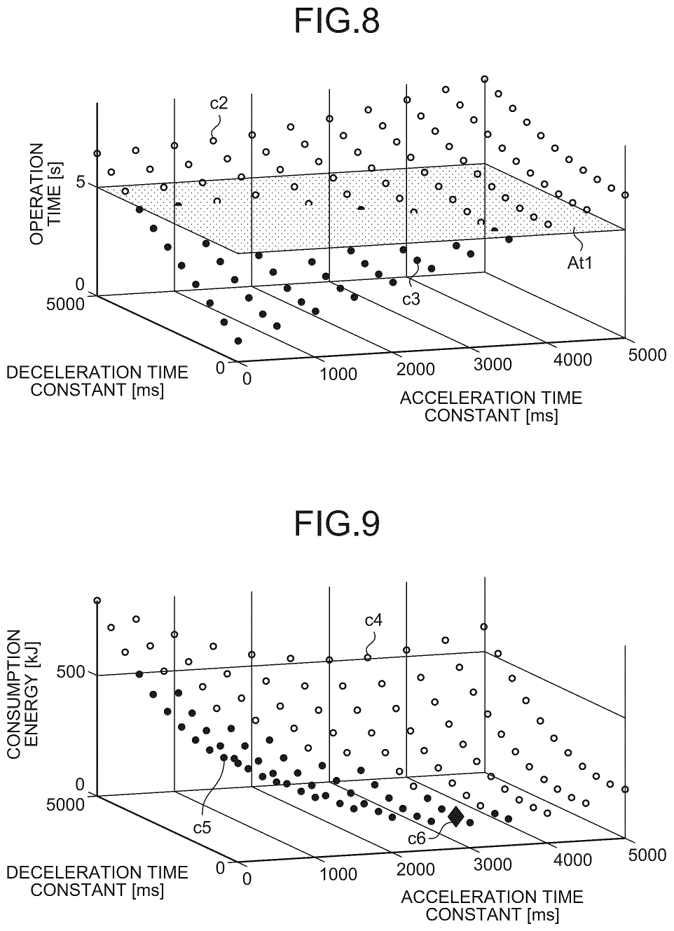

FIG. 8 is a diagram that is used for explaining a process by which the motor control device according to the first embodiment extracts combinations of acceleration time constants and deceleration time constants on the basis of the allowable operation time. FIG. 8 is the diagram schematically illustrating the operation times corresponding to the combinations of the acceleration time constants and the deceleration time constants that are obtained by the optimum parameter computation unit 14. A graph illustrated in FIG. 8 depicts the acceleration time constant on a horizontal axis, the deceleration time constant on a vertical axis, and the operation time on a depth axis. A plane in FIG. 8 represents the allowable operation time At1. The combinations of the acceleration time constants and the deceleration time constants are represented by white dots c2 and black dots c3.

The black dots c3 are dots that each result in the operation time being within the allowable operation time At1, and the white dots c2 are dots that each result in the operation time being beyond the allowable operation time At1. In other words, the combinations of the acceleration time constants and the deceleration time constants within the allowable operation time At1 are represented by the black dots c3, and the combinations of the acceleration time constants and the deceleration time constants beyond the allowable operation time At1 are represented by the white dots c2.

The optimum parameter computation unit 14 extracts, from the operation state table 51, data that include the operation times within the allowable operation time At1. In other words, the optimum parameter computation unit 14 extracts, on the basis of the allowable operation time At1, the row data that correspond to the black dots c3 from the operation state table 51. Next, the optimum parameter computation unit 14 further extracts from among the extracted data, namely the data that include the operation times within the allowable operation time, data including minimum consumption energy.

FIG. 9 is a diagram that is used for explaining a process by which the motor control device according to the first embodiment extracts the combination of the acceleration time constant and the deceleration time constant on the basis of the consumption energy. FIG. 9 is the diagram schematically illustrating the consumption energy corresponding to the combination of the acceleration time constant and the deceleration time constant that is obtained by the optimum parameter computation unit 14. A graph illustrated in FIG. 9 depicts the acceleration time constant on a horizontal axis, the deceleration time constant on a vertical axis, and the consumption energy on a depth axis. In FIG. 9, the combinations of the acceleration time constants and the deceleration time constants are represented by white dots c4 and black dots c5.

Each of the black dots c5 indicates the consumption energy corresponding to the combination of the constant that results in the operation time being within the allowable operation time. Each of the white dots c4 indicates the consumption energy corresponding to the combination of the acceleration time constant and the deceleration time constant that results in the operation time being beyond the allowable operation time. A diamond-shaped dot c6 illustrated as a diamond in FIG. 9 is a dot indicating that the consumption energy is minimum in the range where the operation time falls within the allowable operation time. The optimum parameter computation unit 14 computes the combination of the acceleration time constant and the deceleration time constant that is represented by the diamond-shaped dot c6 as the combination of the optimum acceleration time constant and the optimum deceleration time constant.

The optimum parameter computation unit 14 may apply surface approximation to discrete distributions of the operation time and the consumption energy in relation to the combinations of the acceleration time constants and the deceleration time constants obtained from the operation state table 51. In other words, the optimum parameter computation unit 14 may generate, for each of the two or more drive shafts, the discrete distributions having the operation time and the consumption energy that correspond to the acceleration time constant and the deceleration time constant as variables and apply the surface approximation to the discrete distributions.

Through the application of the surface approximation to the discrete distributions, the optimum parameter computation unit 14 obtains an approximation surface expressing one of the operation time and the consumption energy as a continuous function of the other of the operation time and the consumption energy that correspond to the acceleration time constant and the deceleration time constant. In this case, the optimum parameter computation unit 14 computes, on the basis of the approximation surface, a combination of an acceleration time constant and a deceleration time constant that results in the consumption energy being minimum in a range where the operation time falls within the allowable operation time as the combination of the optimum acceleration time constant and the optimum deceleration time constant.

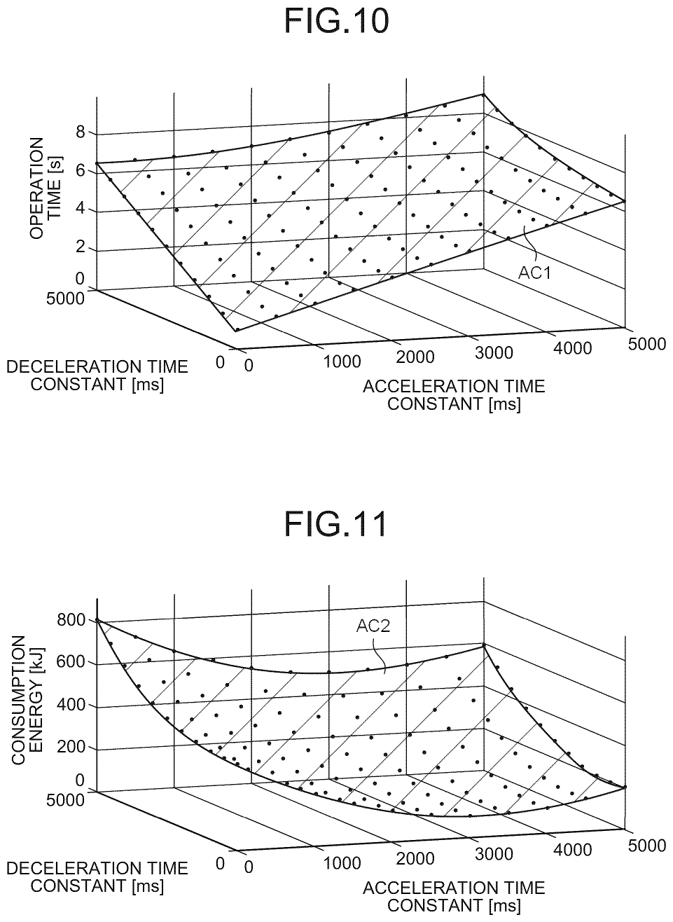

FIG. 10 is a diagram illustrating the operation time resulting from the surface approximation performed by the motor control device according to the first embodiment. FIG. 11 is a diagram illustrating the consumption energy resulting from the surface approximation performed by the motor control device according to the first embodiment. FIG. 10 illustrates the operation time that results from the surface approximation performed by the optimum parameter computation unit 14 in relation to the combinations of the acceleration time constants and the deceleration time constants, that is to say, the example result of the surface approximation applied to the operation time. FIG. 11 illustrates the consumption energy that results from the surface approximation performed by the optimum parameter computation unit 14 in relation to the combinations of the acceleration time constants and the deceleration time constants, that is to say, the example result of the surface approximation applied to the consumption energy.

A graph illustrated in FIG. 10 depicts the acceleration time constant on a horizontal axis, the deceleration time constant on a vertical axis, and the operation time on a depth axis. A graph illustrated in FIG. 11 depicts the acceleration time constant on a horizontal axis, the deceleration time constant on a vertical axis, and the consumption energy on a depth axis. The graph illustrated in FIG. 10 is a graph resulting from the surface approximation applied to the graph illustrated in FIG. 8. The graph illustrated in FIG. 11 is a graph resulting from the surface approximation applied to the graph illustrated in FIG. 9.

A plane in FIG. 10 represents an approximation surface AC1 of the operation time, and a plane in FIG. 11 represents an approximation surface AC2 of the consumption energy. On the basis of the approximation surfaces AC1 and AC2, the optimum parameter computation unit 14 computes the combination of the acceleration time constant and the deceleration time constant that results in the consumption energy being minimum in the range where the operation time falls within the allowable operation time as the optimum parameters.

When computing the optimum parameters on the basis of the approximation surfaces AC1 and AC2, the optimum parameter computation unit 14 is enabled to compute the optimum parameters not from the pre-prepared combinations of the acceleration and deceleration time constants, but from continuous combinations of acceleration and deceleration time constants. Therefore, the optimum parameter computation unit 14 is capable of accurate optimum parameter computation.

Each optimum parameter computation unit 14 computes, among the respective operation times of the drive shafts that are each associated with the optimum parameters, a maximum time (maximum value) as an evaluation period and computes drive shaft-specific operation start timing that results in the consumption energy being minimum during the evaluation period. In other words, each optimum parameter computation unit 14 computes the drive shaft-specific operation start timing so that the consumption energy becomes minimum during the evaluation period, which is the maximum one of the respective operation times of the plural drive shafts. Each optimum parameter computation unit 14 computes the operation start timing after computing the optimum parameters. The operation start timing corresponds to a delay in timing for the drive shaft to start operating.

Each optimum parameter computation unit 14 compares, for the drive shaft, power values at the start and end of the operation. When the power at the start of the operation is less than the power at the end of the operation, the optimum parameter computation unit 14 computes a difference between the evaluation period and the operation time as the operation start timing. If, on the other hand, the power at the start of the operation is greater than or equal to the power at the end of the operation, each optimum parameter computation unit 14 computes 0 as the operation start timing.

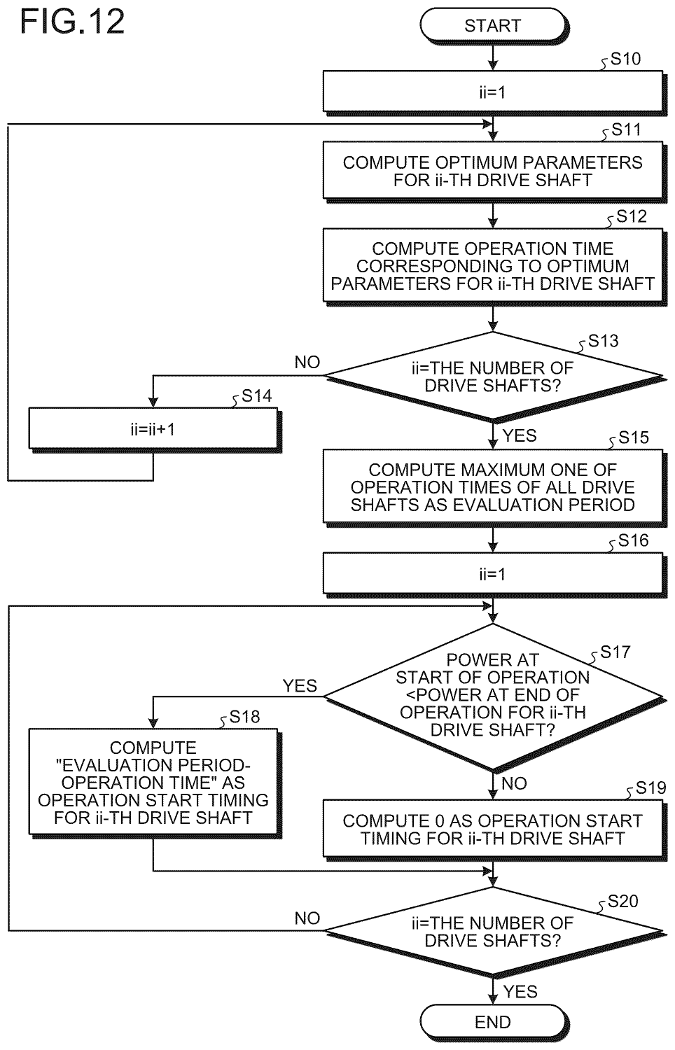

A description is provided here of a procedure of a process by which the optimum parameter computation unit 14 computes the operation start timing. FIG. 12 is a flowchart illustrating the procedure of the process that is performed by the optimum parameter computation unit of the motor control device according to the first embodiment. FIG. 12 is the flowchart illustrative of an operation sequence of the optimum parameter computation unit 14. The optimum parameter computation unit 14 performs the process illustrated in FIG. 12 for each synchronous operation command included in the set (for each block).

The optimum parameter computation unit 14 sets ii that indicates an ii-th drive shaft (where it is a natural number) to 1 (step S10). The optimum parameter computation unit 14 computes the optimum parameters for the ii-th drive shaft (step S11). The optimum parameter computation unit 14 computes the operation time that corresponds to the optimum parameters for the ii-th drive shaft (step S12).

The optimum parameter computation unit 14 determines whether ii=the number of drive shafts or not (step S13). If the optimum parameter computation unit 14 determines that ii is not equal to the number of drive shafts (step S13, No), the optimum parameter computation unit 14 sets ii to ii+1 (step S14). The optimum parameter computation unit 14 then performs the operations of steps S11 to S13.

The optimum parameter computation unit 14 repeats the operation of step S14 and the operations of steps S11 to S13 until the optimum parameter computation unit 14 determines that ii is equal to the number of drive shafts.

If the optimum parameter computation unit 14 determines that ii is equal to the number of drive shafts (step S13, Yes), the optimum parameter computation unit 14 computes the maximum one of the operation times of all the drive shafts included in the set of synchronous operation commands as the evaluation period (step S15). For example, when the operation command for the spindle and the operation command for the feed shaft are included in the set of synchronous operation commands, with the operation time of the feed shaft longer than the operation time of the spindle, each optimum parameter computation unit 14 sets the operation time of the feed shaft as the evaluation period.

The optimum parameter computation unit 14 sets ii, which indicates the ii-th drive shaft, to 1 (step S16). The optimum parameter computation unit 14 determines whether the power at the start of operation<the power at the end of operation is satisfied or not for the ii-th drive shaft (step S17). In other words, the optimum parameter computation unit 14 determines whether or not the power at the start of operation is less than the power at the end of operation for the ii-th drive shaft.

If the optimum parameter computation unit 14 determines that the power at the start of operation<the power at the end of operation for the ii-th drive shaft (step S17, Yes), the optimum parameter computation unit 14 computes “the evaluation period-the operation time” as the operation start timing for the ii-th drive shaft (step S18).

If, on the other hand, the optimum parameter computation unit 14 determines that the power at the start of operation the power at the end of operation for the ii-th drive shaft (step S17, No), the optimum parameter computation unit 14 computes 0 as the operation start timing for the ii-th drive shaft (step S19).

After step S18 or S19, the optimum parameter computation unit 14 determines whether ii=the number of drive shafts or not (step S20). If the optimum parameter computation unit 14 determines that ii is not equal to the number of drive shafts (step S20, No), the optimum parameter computation unit 14 returns to the operation of step S17 and performs the operations of steps S17 and S18 or the operations of steps S17 and S19.

The optimum parameter computation unit 14 repeats the operation of step S20 and the operations of steps S17 to S19 until the optimum parameter computation unit 14 determines that ii is equal to the number of drive shafts. If the optimum parameter computation unit 14 determines that ii is equal to the number of drive shafts (step S20, Yes), the optimum parameter computation unit 14 ends the operation start timing computation process.

In this way, the optimum parameter computation unit 14 computes the optimum parameters and the operation start timing for each drive shaft. The optimum parameter computation unit 14 sends the drive shaft-specific optimum parameters and the drive shaft-specific operation start timing that the optimum parameter computation unit 14 has computed to the motor control unit 15.

For the synchronous operation commands, the motor control unit 15 generates control signals for the motors 4 on the basis of the optimum parameters and the operation start timings that have been computed by the optimum parameter computation units 14, thus causing the drive shafts to operate as desired.

For each drive shaft, the motor control unit 15 waits for a time that corresponds to the operation start timing from operation start time before starting output of a command. In other words, command start time for each drive shaft is delayed by the time that corresponds to the operation start timing by the motor control unit 15.

A control method by which the motor control unit 15 controls the motors 4 may be proportional-integral-differential (PID) control or pulse-width modulation (PWM) control.

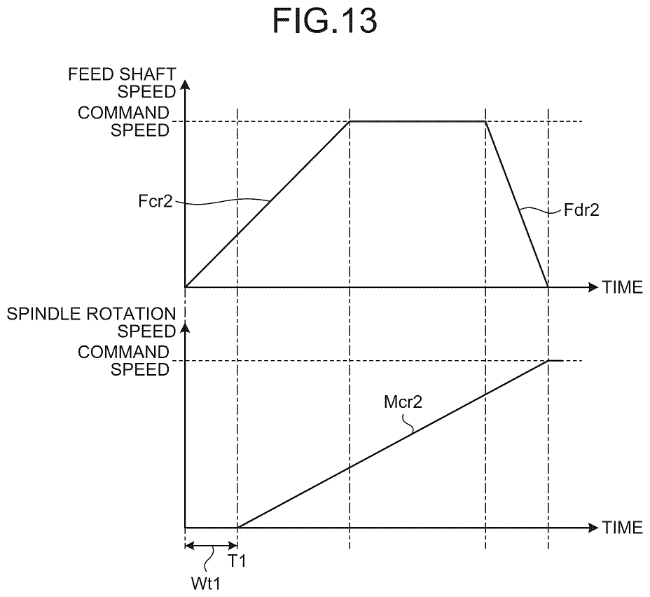

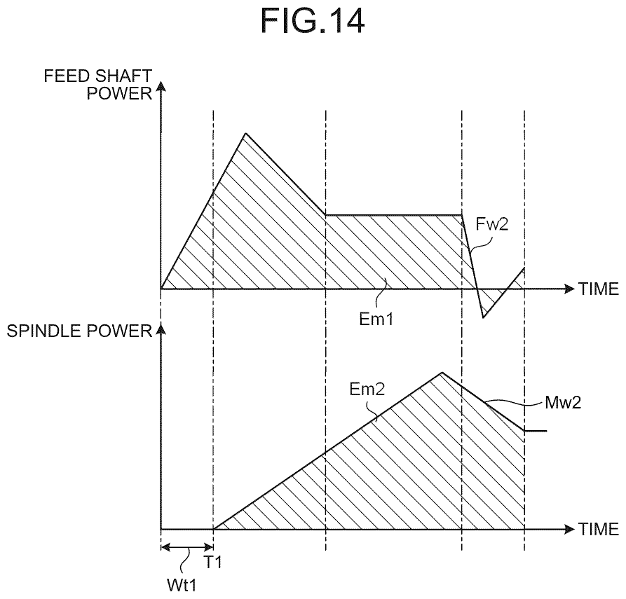

FIG. 13 is a diagram illustrating first example command patterns using optimum parameters computed by the motor control device according to the first embodiment. FIG. 14 is a diagram illustrating first example power waveforms that result from the use of the optimum parameters computed by the motor control device according to the first embodiment. The power waveforms illustrated in FIG. 14 correspond to the command patterns illustrated in FIG. 13.

The command patterns and the power waveforms illustrated in FIGS. 13 and 14 exemplify cases where an operation time of the spindle is shorter than an operation time of the feed shaft and where a power value at the start of operation is smaller than a power value at the end of operation for the spindle.

An upper graph illustrated in FIG. 13 depicts time on a horizontal axis and the feed shaft speed on a vertical axis. A lower graph illustrated in FIG. 13 depicts time on a horizontal axis and the rotation speed of the spindle (spindle rotation speed) on a vertical axis. An upper graph illustrated in FIG. 14 depicts time on a horizontal axis and the feed shaft power on a vertical axis. A lower graph illustrated in FIG. 14 depicts time on a horizontal axis and the spindle power on a vertical axis.

FIG. 13 is the diagram where the command pattern for the feed shaft and the command pattern for the spindle are schematically illustrated, with the optimum parameters set. FIG. 14 is the diagram where the power waveform of the feed shaft and the power waveform of the spindle are schematically illustrated, resulting from the setting of the optimum parameters. The optimum parameters in the case of FIG. 13 include an optimum feed shaft acceleration time constant Fcr2 that is an optimum acceleration time constant for the feed shaft, an optimum feed shaft deceleration time constant Fdr2 that is an optimum deceleration time constant for the feed shaft, and an optimum spindle acceleration time constant Mcr2 that is an optimum acceleration time constant for the spindle.

As illustrated in FIG. 13, the command pattern with the set optimum parameters for the feed shaft is such that the feed shaft is to accelerate or gain speed in accordance with the optimum feed shaft acceleration time constant Fcr2 until reaching a command speed specified in the machining program 2 and is to be driven at this command speed. Subsequently, the feed shaft is to decelerate in accordance with the optimum feed shaft deceleration time constant Fdr2 and stop. The command pattern with the set optimum parameter for the spindle is such that the spindle rotation speed of the spindle is to increase in accordance with the optimum spindle acceleration time constant Mcr2.

Since the command patterns illustrated in FIG. 13 and the power waveforms show that the operation time of the feed shaft is maximum among the operation times of the drive shafts, the optimum parameter computation units 14 compute the operation time of the feed shaft as the evaluation period.

In the case of the feed shaft, the power at the start of operation<the power at the end of operation. Therefore, the optimum parameter computation unit 14 computes “the evaluation period-the operation time”=0 as the operation start timing for the feed shaft.

In the case of the spindle, the power at the start of operation<the power at the end of operation. Therefore, the optimum parameter computation unit 14 computes, for the spindle, operation start timing T1 that equals “the evaluation period-the operation time”. In other words, the optimum parameter computation unit 14 computes, for the spindle, the operation start timing T1 that equals “the feed shaft's operation time, which is the evaluation period, minus the spindle's operation time”. This operation start timing T1 corresponds to a time Wt1 between when the feed shaft starts operating and when the spindle starts operating.

Therefore, according to the command pattern with the set optimum parameter for the spindle, the motor control unit 15 waits for the time Wt1 from the feed shaft's operation start time before starting output of a command to the spindle. As a result, the feed shaft reaches a desired position when the spindle reaches a command speed. In other words, the spindle does not to reach the command speed until the feed shaft reaches the desired position.

If the spindle reaches the command speed before the feed shaft reaches the desired position, the spindle rotates wastefully before the feed shaft reaches the desired position, leading to an increase in the consumption energy of the spindle. The motor control device 10A according to the first embodiment waits for the time Wt1 before starting the operation of the spindle, thus enabling the arrival of the feed shaft at the desired position to coincide with the spindle's reaching the command speed and consequently preventing the increase in the consumption energy.

As illustrated in FIG. 14, a feed shaft power waveform Fw2 that refers to the feed shaft's power waveform resulting from the setting of the optimum parameters is a collection of power values sampled within the operation time of the feed shaft. The optimum parameters for the feed shaft refer to the combination of the optimum feed shaft acceleration time constant Fcr2 and the optimum feed shaft deceleration time constant Fdr2, and the consumption energy of the feed shaft in this case is minimum feed shaft consumption energy Em1.

A spindle power waveform Mw2 that refers to the spindle's power waveform resulting from the setting of the optimum parameter is a collection of power values sampled within the operation time of the spindle. The optimum parameter for the spindle refers to the optimum spindle acceleration time constant Mcr2, and the consumption energy of the spindle in this case is minimum spindle consumption energy Em2.

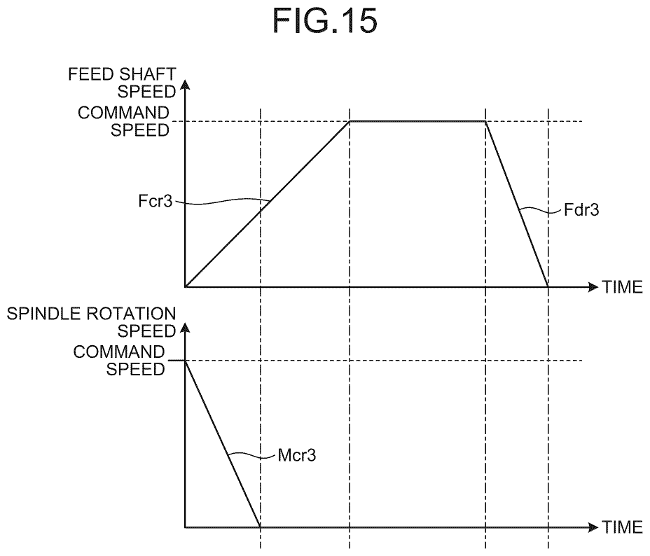

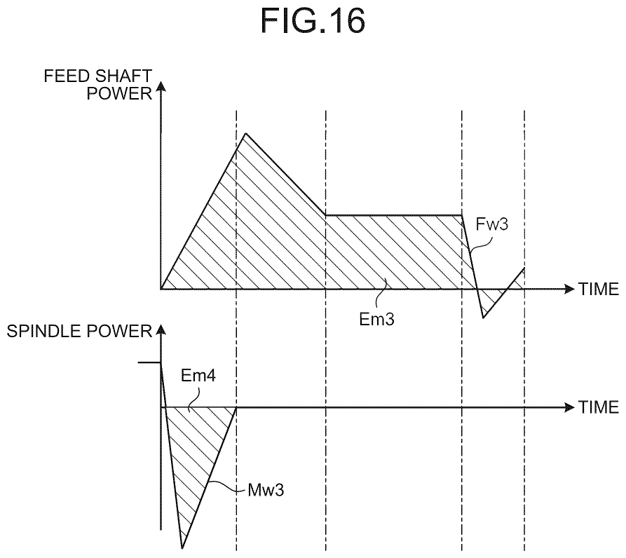

FIG. 15 is a diagram illustrating second example command patterns using optimum parameters computed by the motor control device according to the first embodiment. FIG. 16 is a diagram illustrating second example power waveforms that result from the use of the optimum parameters computed by the motor control device according to the first embodiment. The power waveforms illustrated in FIG. 16 correspond to the command patterns illustrated in FIG. 15.

The command patterns and the power waveforms illustrated in FIGS. 15 and 16 exemplify cases where an operation time of the spindle is shorter than an operation time of the feed shaft and where a power value at the start of operation is greater than a power value at the end of operation for the spindle.

An upper graph illustrated in FIG. 15 depicts time on a horizontal axis and the feed shaft speed on a vertical axis. A lower graph illustrated in FIG. 15 depicts time on a horizontal axis and the rotation speed of the spindle (spindle rotation speed) on a vertical axis. An upper graph illustrated in FIG. 16 depicts time on a horizontal axis and the feed shaft power on a vertical axis. A lower graph illustrated in FIG. 16 depicts time on a horizontal axis and the spindle power on a vertical axis.

FIG. 15 is the diagram where the command pattern for the feed shaft and the command pattern for the spindle are schematically illustrated, with the optimum parameters set. FIG. 16 is the diagram where the power waveform of the feed shaft and the power waveform of the spindle are schematically illustrated, resulting from the setting of the optimum parameters. The optimum parameters in the case of FIG. 15 include an optimum feed shaft acceleration time constant Fcr3 that is an optimum acceleration time constant for the feed shaft, an optimum feed shaft deceleration time constant Fdr3 that is an optimum deceleration time constant for the feed shaft, and an optimum spindle acceleration time constant Mcr3 that is an optimum acceleration time constant for the spindle.

As illustrated in FIG. 15, the command pattern with the set optimum parameters for the feed shaft is such that the feed shaft is to accelerate or gain speed in accordance with the optimum feed shaft acceleration time constant Fcr3 until reaching a command speed specified in the machining program 2 and is to be driven at this command speed. Subsequently, the feed shaft is to decelerate in accordance with the optimum feed shaft deceleration time constant Fdr3 and stop. The command pattern with the set optimum parameter for the spindle is such that the spindle rotation speed of the spindle is to increase in accordance with the optimum spindle acceleration time constant Mcr3.

Since the command patterns illustrated in FIG. 15 and the power waveforms show that the operation time of the feed shaft is maximum among the operation times of the drive shafts, the optimum parameter computation units 14 compute the operation time of the feed shaft as the evaluation period.

In the case of the feed shaft, the power at the start of operation<the power at the end of operation. Therefore, the optimum parameter computation unit 14 computes “the evaluation period-the operation time”=0 as the operation start timing for the feed shaft.

In the case of the spindle, the power at the start of operation the power at the end of operation. Therefore, the optimum parameter computation unit 14 computes, for the spindle, operation start timing that equals 0.

As illustrated in FIG. 16, a feed shaft power waveform Fw3 that refers to the feed shaft's power waveform resulting from the setting of the optimum parameters is a collection of power values sampled within the operation time of the feed shaft. The optimum parameters for the feed shaft refer to the combination of the optimum feed shaft acceleration time constant Fcr3 and the optimum feed shaft deceleration time constant Fdr3, and the consumption energy of the feed shaft in this case is minimum feed shaft consumption energy Em3.

A spindle power waveform Mw3 that refers to the spindle's power waveform resulting from the setting of the optimum parameter is a collection of power values sampled within the operation time of the spindle. The optimum parameter for the spindle refers to the optimum spindle acceleration time constant Mcr3, and the consumption energy of the spindle in this case is minimum spindle consumption energy Em4.

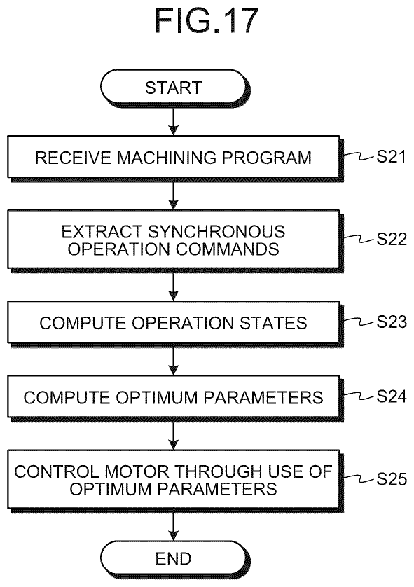

FIG. 17 is a flowchart illustrating a procedure of a process that is performed by the motor control device according to the first embodiment. In the motor control device 10A, the synchronous operation command extraction unit 11 receives the machining program 2 (step S21). The synchronous operation command extraction unit 11 extracts the synchronous operation commands from the machining program 2 (step S22).

Each operation state computation unit 12 computes the operation states that correspond to the synchronous operation command and are specific to the drive shaft included in the synchronous operation command (step S23). Each operation state computation unit 12 sends, to the optimum parameter computation unit 14, the drive shaft-specific operation state table 51 where the operation states are stored. Each allowable operation time input unit 13 inputs the buffer time for the operation time to the optimum parameter computation unit 14.

Each optimum parameter computation unit 14 computes the sum of the minimum operation time computed by the operation state computation unit 12 and the buffer time as the allowable operation time. For each synchronous operation command, each optimum parameter computation unit 14 computes the drive shaft-specific optimum acceleration time constant and the drive shaft-specific optimum deceleration time constant as the optimum parameters on the basis of the operation state table 51 (step S24). Specifically, each optimum parameter computation unit 14 computes the drive shaft-specific combination of the acceleration time constant and the deceleration time constant that results in the consumption energy being minimum in the range where the operation time falls within the allowable operation time as the combination of the optimum acceleration time constant and the optimum deceleration time constant. Using the drive shaft-specific combination of the optimum acceleration time constant and the optimum deceleration time constant as the optimum parameters, the motor control unit 15 controls the motor 4 (step S25).

By the way, setting one optimum parameter for the entire machining program 2 does not allow for reduced consumption energy of an entire process that includes operations other than machining, such as tool changes.

In contrast, the motor control device 10A according to the first embodiment extracts the blocks where the set-point control is to be continuously commanded for two or more of the drive shafts that synchronize as the set of synchronous operation commands and computes the optimum parameters for each of the extracted synchronous operation commands. Therefore, the motor control device 10A is capable of setting the parameters that allow for a reduction in required time (cycle time) and minimized consumption energy for the operation that does not directly contribute to machining, such as the tool change.

The motor control device 10A is capable of minimizing overall consumption energy of the tool change operations included in the machining program 2 by extracting the tool change operations from the machining program 2 and setting optimum parameters for each of the tool change operations. Furthermore, since the motor control device 10A extracts the tool change operation from within the machining program 2 and sets the optimum parameters, the motor control device 10A enables reduced time required for the optimum parameter computation.

As described above, the motor control device 10A according to the first embodiment extracts the blocks where the set-point control is to be continuously commanded for the plural drive shafts that synchronize from within the machining program 2 and extracts the synchronous operation commands included in the blocks. Furthermore, the motor control device 10A computes, on the basis of the acceleration time constant and the deceleration time constant, the operation time and the consumption energy that are associated with machining to be performed with the machining program 2. For each of the synchronous operation commands, the motor control device 10A computes the constant that result in the operation time of the drive shaft being within the allowable operation time and the consumption energy being minimum as the optimum parameters.

In this way, the motor control device 10A is capable of setting, for the operation other than machining, the parameters that allow for the shorter cycle time and the minimized consumption energy. Therefore, the motor control device 10A is capable of controlling the motors 4 through the created machining program 2 that can reduce the cycle time and minimize the consumption energy for the operation other than machining, such as the tool change,

### Second Embodiment

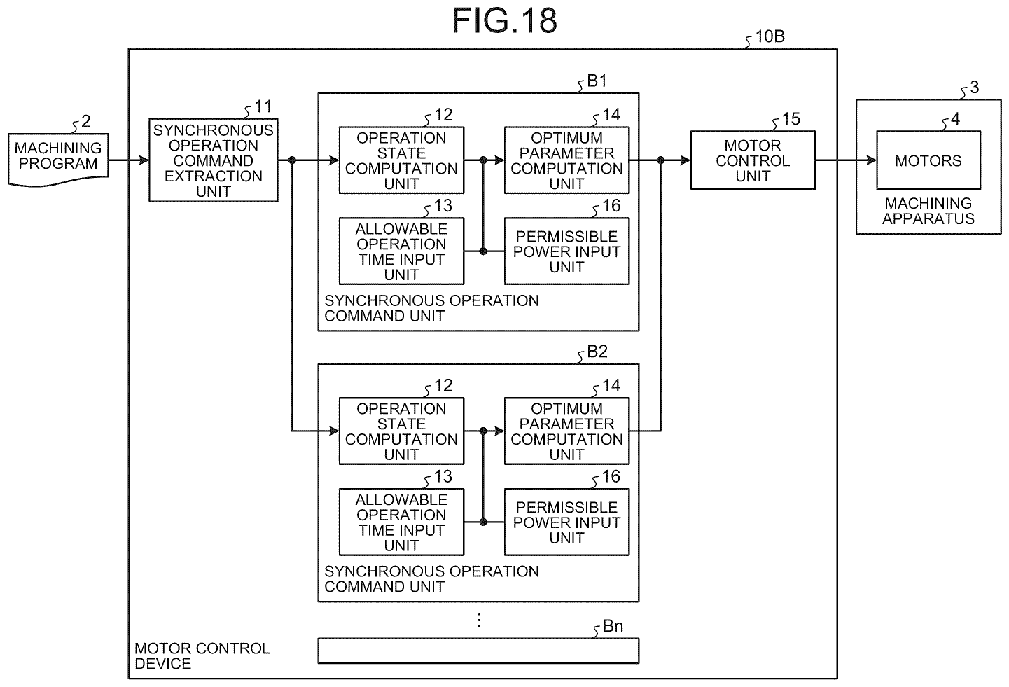

With reference to FIGS. 18 to 20, a description is provided next of a second embodiment. In the second embodiment, optimum parameters are set to ensure that power values of feed shafts and a power value of a spindle total a value that falls within a permissible range.

FIG. 18 is a functional block diagram of a motor control device according to the second embodiment. Among constituent elements illustrated in FIG. 18, constituent elements that fulfill the same functions as those of the first embodiment's motor control device 10A illustrated in FIG. 1 have the same reference characters and are not described in order to omit redundancy.

The motor control device 10B according to the second embodiment includes synchronous operation command units B1 to Bn instead of the synchronous operation command units A1 to An, as compared to the motor control device 10A. In addition to the constituent elements of the synchronous operation command units A1 to An, the synchronous operation command units B1 to Bn have respective permissible power input units 16. The motor control device 10B is described below as having synchronous operation command units B1 and B2 as the synchronous operation command units.

The permissible power input units 16 are connected respectively to the optimum parameter computation units 14. Each permissible power input unit 16 stores minimum permissible power and maximum permissible power that indicate the permissible range for power waveforms and inputs the stored minimum permissible power and the stored maximum permissible power to the optimum parameter computation unit 14.

The minimum permissible power refers to maximum regenerative power of converters (included in the motor control unit 15) that are used in controlling the motors 4. The maximum permissible power refers to maximum powering power of the converters, which are used in controlling the motors 4. Powering power refers to power in a state of being supplied to the motor 4, while regenerative power refers to power of the motor 4 in a state of flowing to a power supply side as regenerative energy. The maximum regenerative power and the maximum powering power of the converters are limits corresponding to the permissible range. The permissible power input units 16 input the minimum permissible power and the maximum permissible power to the optimum parameter computation units 14.

Each of the operation state computation units 12 according to the second embodiment computes, on the basis of an acceleration time constant and a deceleration time constant for the drive shaft, drive shaft-specific instantaneous power values that are to be power values (power consumptions) of the drive shaft at time points during operation of the drive shaft. Each operation state computation unit 12 computes, for each time point within the operation time, the sum of the instantaneous power value(s) of the feed shaft(s) and the instantaneous power value of the spindle, that is to say, the sum of the power values (hereinafter referred to as the total power value).

Each of the optimum parameter computation units 14 of the motor control device 10B performs a process below in addition to the process that the optimum parameter computation unit 14 of the motor control device 10A performs. In other words, for a synchronous operation command, each optimum parameter computation unit 14 of the motor control device 10B computes an acceleration time constant, a deceleration time constant, and operation start timing that result in the operation time being within an allowable operation time, a minimum one of the total power values being greater than or equal to the minimum permissible power of the range, a maximum one of the total power values being less than or equal to the maximum permissible power of the range, and total consumption energy of the drive shafts being minimum.

When a minimum one of the total power values is less than the minimum permissible power or when a maximum one of the total power values is greater than the maximum permissible power at some time point, for the drive shafts, the optimum parameter computation units 14 each change at least one of the operation start timing, the optimum acceleration time constant, or the optimum deceleration time constant. In this way, each optimum parameter computation unit 14 computes the acceleration time constant, the deceleration time constant, and the operation start timing that result in the operation time being within the allowable operation time, the minimum one of the total power values being greater than or equal to the minimum permissible power of the range, the maximum one of the total power values being less than or equal to the maximum permissible power of the range, and the total consumption energy of the drive shafts being minimum. In other words, each optimum parameter computation unit 14 computes the acceleration time constant, the deceleration time constant, and the operation start timing that result in the operation time being within the allowable operation time and the total power values falling within the permissible range.

As described above, each optimum parameter computation unit 14 changes the at least one of the operation start timing, the optimum acceleration time constant, or the optimum deceleration time constant to meet the allowable operation time, the minimum permissible power, and the maximum permissible power. Each optimum parameter computation unit 14 changes the at least one of the operation start timing, the optimum acceleration time constant, or the optimum deceleration time constant after computing the optimum parameters and the operation start timing.

A description is provided here of command patterns using optimum parameters computed, with the range for total power values taken into consideration, by the optimum parameter computation units 14 and power waveforms that result from the use of the optimum parameters.

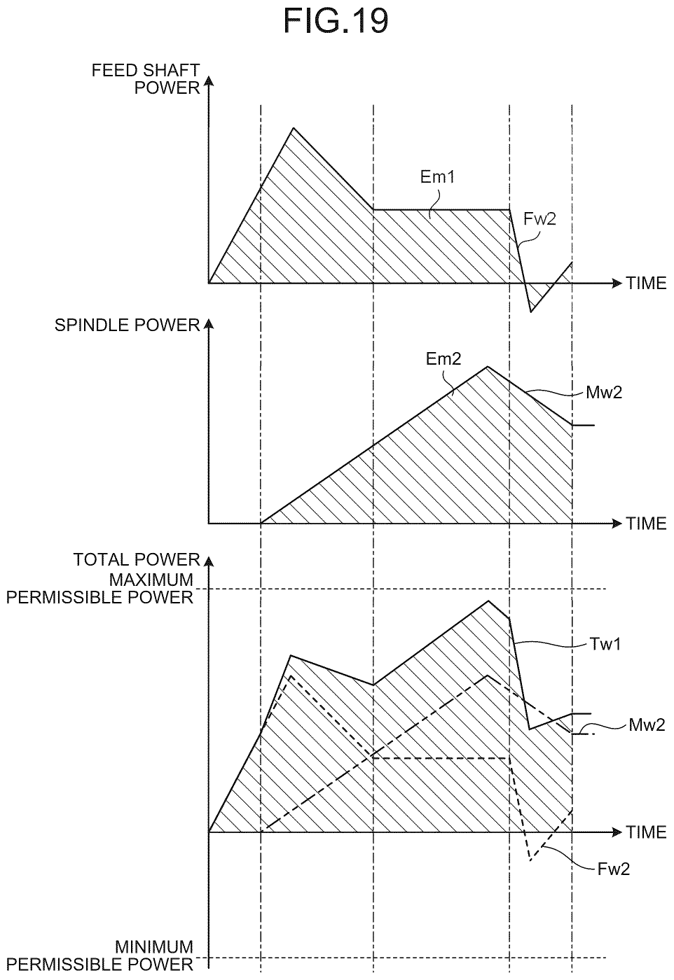

FIG. 19 is a diagram illustrating first example power waveforms that result from use of optimum parameters computed, with the range for total power values taken into consideration, by the motor control device according to the second embodiment. An upper graph illustrated in FIG. 19 depicts time on a horizontal axis and the feed shaft power on a vertical axis. A middle graph illustrated in FIG. 19 depicts time on a horizontal axis and the spindle power on a vertical axis. A lower graph illustrated in FIG. 19 depicts time on a horizontal axis and the maximum permissible power. FIG. 19 illustrates the power waveforms for a case where the spindle accelerates. The power waveforms illustrated in FIG. 19 correspond to the command patterns illustrated in FIG. 13.

The optimum parameter computation units 14 compute the optimum parameters in the same manner as in the first embodiment. The command patterns illustrated in FIG. 13 show the example optimum parameters computed by the optimum parameter computation units 14.

Furthermore, the optimum parameter computation units 14 compute the power waveforms of the feed shaft and the spindle within the operation time in the same manner as in the first embodiment. In other words, the optimum parameter computation units 14 compute, on the basis of the acceleration time constants and the deceleration time constants for the drive shafts, instantaneous power values that are to be power values (power consumptions) of the drive shafts at time points to compute the power waveforms of the feed shaft and the spindle. The waveforms illustrated in FIG. 14 are the example power waveforms of the feed shaft and the spindle that have been computed by the optimum parameter computation units 14.

The optimum parameter computation units 14 compute, for each time within the operation time, a total power value that is the sum of the power value of the feed shaft and the power value of the spindle, that is to say, the sum of and compute a power waveform that corresponds to the total power values. A total power waveform Tw1 illustrated in FIG. 19 is the power waveform resulting from the addition of each power value of the spindle power waveform Mw1 and each power value of the feed shaft power waveform Fw1.

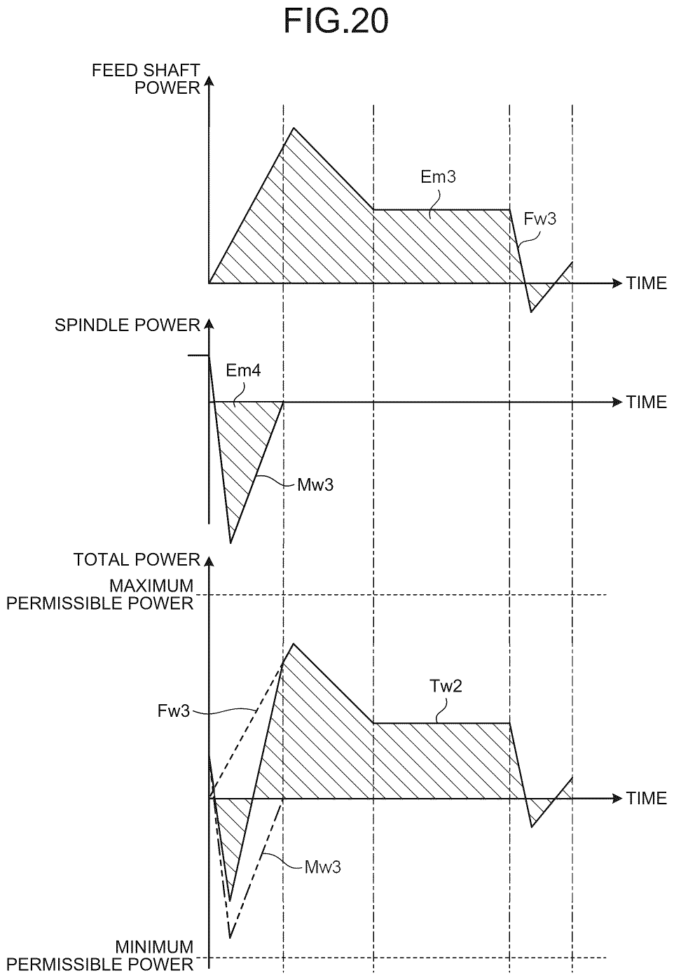

FIG. 20 is a diagram illustrating second example power waveforms that result from use of optimum parameters computed, with the range for total power values taken into consideration, by the motor control device according to the second embodiment. An upper graph illustrated in FIG. 20 depicts time on a horizontal axis and the feed shaft power on a vertical axis. A middle graph illustrated in FIG. 20 depicts time on a horizontal axis and the spindle power on a vertical axis. A lower graph illustrated in FIG. 20 depicts time on a horizontal axis and the maximum permissible power. FIG. 20 illustrates the power waveforms for a case where the spindle decelerates. The power waveforms illustrated in FIG. 20 correspond to the command patterns illustrated in FIG. 15.

The optimum parameter computation units 14 compute the optimum parameters in the same manner as in the first embodiment. The command patterns illustrated in FIG. 15 show the example optimum parameters computed by the optimum parameter computation units 14.

Furthermore, the optimum parameter computation units 14 compute the power waveforms of the feed shaft and the spindle within the operation time in the same manner as in the first embodiment. In other words, the optimum parameter computation units 14 compute, on the basis of the acceleration time constants and the deceleration time constants for the drive shafts, instantaneous power values that are to be power values (power consumptions) of the drive shafts at time points to compute the power waveforms of the feed shaft and the spindle. The waveforms illustrated in FIG. 16 are the example power waveforms of the feed shaft and the spindle that have been computed by the optimum parameter computation units 14.

The optimum parameter computation units 14 compute, for each time within the operation time, a total power value that is the sum of the power value of the feed shaft and the power value of the spindle, that is to say, the sum of and compute a power waveform that corresponds to the total power values. A total power waveform Tw2 illustrated in FIG. 20 is the power waveform resulting from the addition of each power value of the spindle power waveform Mw2 and each power value of the feed shaft power waveform Fw2.

The optimum parameter computation units 14 determine whether or not a minimum one of total power values within the operation time is less than the minimum permissible power. Furthermore, the optimum parameter computation units 14 determine whether or not a maximum one of the total power values within the operation time is greater than the maximum permissible power. In other words, the optimum parameter computation units 14 determine whether or not the power values of each of the total power waveforms Tw1 and Tw2 are greater than or equal to the minimum permissible power and less than or equal to the maximum permissible power.

When the minimum one of the total power values within the operation time is less than the minimum permissible power, for the feed shaft and the spindle, the optimum parameter computation units 14 each change at least one of the operation start timing, the optimum acceleration time constant, or the optimum deceleration time constant. In this case, the optimum parameter computation units 14 each change the at least one of the operation start timing, the optimum acceleration time constant, or the optimum deceleration time constant so that total power values within the operation time fall within the permissible range.

When the maximum one of the total power values within the operation time is greater than the maximum permissible power, for the feed shaft and the spindle, the optimum parameter computation units 14 each change at least one of the operation start timing, the optimum acceleration time constant, or the optimum deceleration time constant. In this case, the optimum parameter computation units 14 each change the at least one of the operation start timing, the optimum acceleration time constant, or the optimum deceleration time constant so that total power values within the operation time fall within the permissible range.

As described above, the motor control device 10B according to the second embodiment sets the optimum parameters so that the power value(s) of the feed shaft(s) and the power value of the spindle total the power value that falls within the permissible range. Therefore, the motor control device 10B is capable of computing the optimum parameters, with the maximum regenerative power and the maximum powering power of the converters not exceeded as the limits.

### Third Embodiment

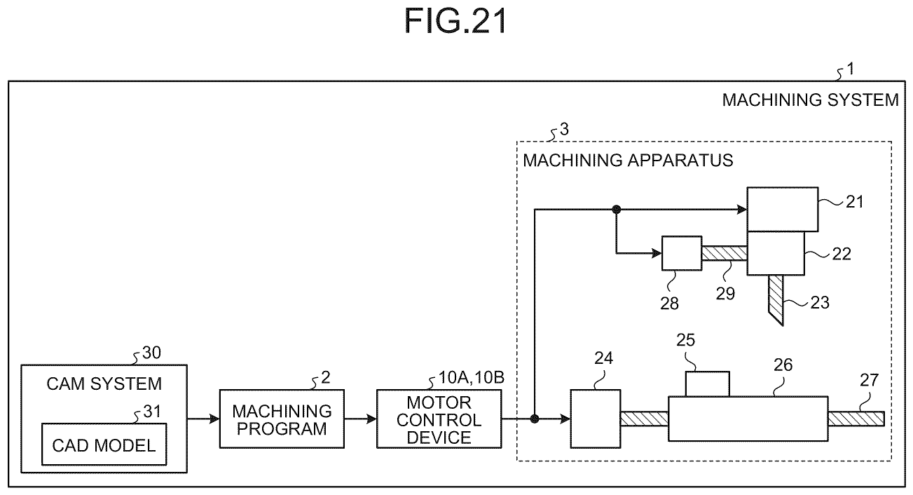

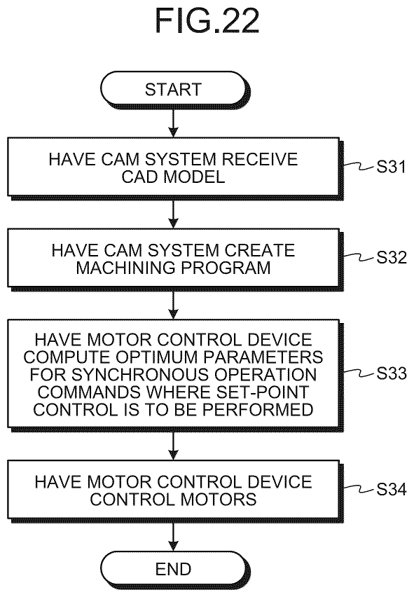

With reference to FIGS. 21 and 22, a description is provided next of a third embodiment. In the third embodiment, the motor control device 10A or 10B is applied to a machining system that uses the machining program 2 to machine a workpiece.

FIG. 21 is a functional block diagram of the machining system according to the third embodiment. The machining system 1 includes a CAM system 30 with an input computer-aided design (CAD) model 31, the machining program 2, the motor control device 10A or 10B, and the machining apparatus 3. A description is provided here of the machining system 1 to which the motor control device 10A is applied.

The CAM system 30 creates, using the CAD model 31, the machining program 2 with which the machining apparatus 3 is controlled and inputs the created machining program 2 to the motor control device 10A.

The machining apparatus 3 includes a spindle motor 21, a spindle 22, a tool 23, a feed shaft motor 24, the workpiece 25, a stage 26, a workpiece feed shaft 27, feed shaft motors 28, and tool feed shafts 29. The spindle motor 21 and the feed shaft motors 24 and 28 are connected to the motor control device 10A and rotate in accordance with control signals sent from the motor control device 10A.

The spindle 22 is attached to the spindle motor 21, and the tool 23 is attached to the spindle 22. The spindle motor 21 rotates the tool 23, with the spindle 22 serving as a rotating shaft.

The tool feed shafts 29, which are rod-shaped, are attached respectively to the feed shaft motors 28, and the spindle 22 is coupled to the tool feed shafts 29. The feed shaft motors 28 rotate the tool feed shafts 29, thus moving the spindle 22 axially of the tool feed shafts 29.

For example, the feed shaft motors 28 of the machining apparatus 3 are three in number, with the tool feed shafts 29 being three in number. In this case, the feed shaft motors 28 include an X-axis motor that moves the spindle 22 along an X-axis, a Y-axis motor that moves the spindle 22 along a Y-axis, and a Z-axis motor that moves the spindle 22 along a Z-axis. The tool feed shafts 29 include a feed shaft that extends in an X-axis direction and is connected to the X-axis motor, a feed shaft that extends in a Y-axis direction and is connected to the Y-axis motor, and a feed shaft that extends in a Z-axis direction and is connected to the Z-axis motor. Therefore, the spindle 22 is moved along the X-, Y-, and Z-axes by the three feed shaft motors 28 and the three tool feed shafts 29.

The workpiece feed shaft 27, which is rod-shaped, is attached to the feed shaft motor 24, and the stage 26 is coupled to the workpiece feed shaft 27. The feed shaft motor 24 rotates the workpiece feed shaft 27, thus moving the stage 26 axially of the workpiece feed shaft 27, There is the at least one workpiece feed shaft 27 extending along one of the X-axis, the Y-axis, the Z-axis, an A-axis, a B-axis, and a C-axis. The feed shaft motor(s) 24 and the workpiece feed shaft(s) 27 are the same in number. The workpiece 25, which is a piece of work to be machined, is placed on the stage 26.

The feed shaft motors 28 move the tool 23 to a machining position via the tool feed shafts 29 and the spindle 22, and the feed shaft motor 24 moves the workpiece 25 to the machining position via the workpiece feed shaft 27 and the stage 26. The spindle motor 21 rotates the tool 23 at the machining position via the spindle 22. In this way, the workpiece 25 is machined by the tool 23.

When a tool change is to follow the machining of the workpiece 25, the feed shaft motors 28 move the tool 23 to a tool change position while the spindle motor 21 stops the rotation of the tool 23. Commands for the spindle motor 21 and the feed shaft motors 28 in this case are synchronous operation commands.

When the workpiece 25 is to be machined after the tool 23 is changed, the feed shaft motors 28 move the tool 23 to a machining position while the spindle motor 21 starts to rotate the tool 23. Commands for the spindle motor 21 and the feed shaft motors 28 in this case are synchronous operation commands.

The motor control device 10A, which includes the numerical control device, receives the machining program 2 from the CAM system 30. The motor control device 10A generates a set of control signals to move the tool 23 relative to the workpiece 25 in order for the workpiece 25 to be machined. The motor control device 10A generates the set of control signals in the manner described in the first embodiment. The set of control signals includes the control signal for the spindle motor 21 and the control signal(s) for the feed shaft motor(s) 24.

FIG. 22 is a flowchart illustrating a procedure of a process that is performed by the machining system according to the third embodiment. The CAM system 30 of the machining system 1 receives the CAD model 31 (step S31). Using the CAD model 31, the CAM system 30 creates the machining program 2 (step S32).

For synchronous operation commands where set-point control is to be performed, the motor control device 10A computes optimum parameters on the basis of the machining program 2 and allowable operation times (step S33). The motor control device 10A computes combinations of optimum acceleration time constants and optimum deceleration time constants that each result in the consumption energy being minimum within the allowable operation time.

The motor control device 10A generates, using the optimum parameters, control signals and controls the motors 4 through use of the control signals (step S34).

As described above, since the motor control device 10A is applied to the machining system 1, the machining system 1 according to the third embodiment is capable of setting parameters that allow for a shorter cycle time and minimized consumption energy for an operation other than machining as in the first embodiment.

A description is provided here of a hardware configuration of each of the motor control devices 10A and 10B. Each of the motor control devices 10A and 10B is implemented with processing circuitry. The processing circuitry may include a memory and a processor that executes programs stored in the memory or may be dedicated hardware, such as dedicated circuits. The processing circuitry is also referred to as control circuitry.

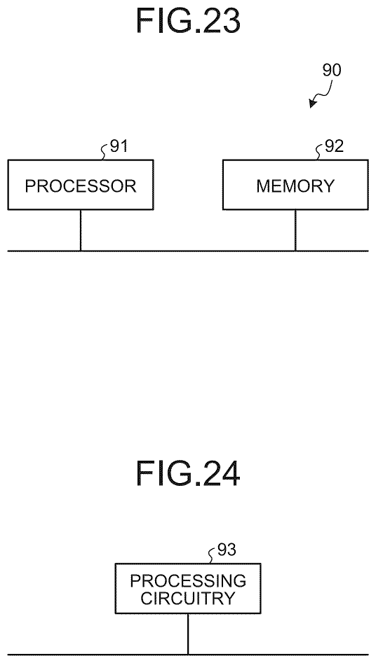

FIG. 23 is a diagram illustrating a configuration example of processing circuitry implemented with a processor and a memory as the processing circuitry of the motor control device according to each of the first through third embodiments. Since the motor control devices 10A and 10B have the same hardware configuration, the hardware configuration of the motor control device 10A is described here.

The processing circuitry 90 illustrated in FIG. 23 is control circuitry and includes the processor 91 and the memory 92. For the processing circuitry 90 that includes the processor 91 and the memory 92, the functions of the processing circuitry 90 are implemented with software, firmware, or a combination of software and firmware. The software or the firmware is described as programs and is stored in the memory 92. In the processing circuitry 90, the processor 91 reads and executes the programs stored in the memory 92 to implement the functions. This means that the memory 92 is included in the processing circuitry 90 to store the programs that result in the execution of the operations of the motor control device 10A. These programs can be said to be programs that cause the functions that the processing circuitry 90 implements to be performed by the motor control device 10A. These programs may be stored in a storage medium and provided or may be provided by another means such as a communication medium. The programs can also be said to be programs that cause the motor control device 10A to perform the motor control process.

Here examples of the processor 91 include a central processing unit (CPU), a processing unit, an arithmetic unit, a microprocessor, a microcomputer, and a digital signal processor (DSP), among others. The processor 91 is included in a personal computer (PC) or a programmable logic controller (PLC). The PLC is also referred to as a sequencer.

Examples that each correspond to the memory 92 include nonvolatile and volatile semiconductor memories, such as a random-access memory (RAM), a read-only memory (ROM), a flash memory, an erasable programmable ROM (EPROM), and an electrically EPROM (EEPROM) (registered trademark), a magnetic disk, a flexible disk, an optical disk, a compact disk, a mini disk, and a digital versatile disc (DVD), among others.

FIG. 24 is a diagram illustrating an example of processing circuitry configured as dedicated hardware to serve as the processing circuitry of the motor control device according to each of the first through third embodiments. Examples that each correspond to the processing circuitry 93 illustrated in FIG. 24 include a single circuit, a composite circuit, a programmed processor, a parallel programmed processor, an application-specific integrated circuit (ASIC), a field-programmable gate array (FPGA), and combinations of these. The processing circuitry 93 may be realized partly by dedicated hardware and partly by software or firmware. By including the dedicated hardware, the software, the firmware or a combination of these, the processing circuitry 93 is capable of implementing the above functions.

The above configurations illustrated in the embodiments are illustrative, can be combined with other techniques that are publicly known, and can be partly omitted or changed without departing from the gist. The embodiments can be combined with each other.

### REFERENCE SIGNS LIST

1 machining system; 2 machining program; 3 machining apparatus; 4 motor; 10A, 10B motor control device; 11 synchronous operation command extraction unit; 12 operation state computation unit; 13 allowable operation time input unit; 14 optimum parameter computation unit; 15 motor control unit; 16 permissible power input unit; 21 spindle motor; 22 spindle; 23 tool; 24, 28 feed shaft motor; 25 workpiece; 26 stage; 27 workpiece feed shaft; 29 tool feed shaft; 30 CAM system; 31 CAD model; 51 operation state table; 90, 93 processing circuitry; 91 processor; 92 memory; A1 to An synchronous operation command units; AC1, AC2 approximation surface; At1 allowable operation time; B1 to Bn synchronous operation command units; Em1, Em3 minimum feed shaft consumption energy; Em2, Em4 minimum spindle consumption energy; Fc1 feed shaft acceleration time constant; Fcr2, Fcr3 optimum feed shaft acceleration time constant; Fd1 feed shaft deceleration time constant; Fdr2, Fdr3 optimum feed shaft deceleration time constant; Fe1 feed shaft consumption energy; Ft1 feed shaft operation time; Fw1 to Fw3 feed shaft power waveforms; Mc1 spindle acceleration time constant; Mcr2, Mcr3 optimum spindle acceleration time constant; Me1 spindle consumption energy; Mt1 spindle operation time; Mw1 to Mw3 spindle power waveforms; T1 operation start timing; Tw1, Tw2 total power waveform; Wt1 time; c1 acceleration time constant; c2, c4 white dot; c3, c5 black dot; c6 diamond-shaped dot; d1 deceleration time constant.

1. A motor control device to generate, on a basis of an acceleration time constant that defines an acceleration time of a drive shaft and a deceleration time constant that defines a deceleration time of the drive shaft, a control signal for a motor that drives the drive shaft, the motor control device comprising:
synchronous operation command extraction circuitry to extract, from within a machining program, blocks where set-point control is to be continuously commanded for a plurality of the drive shafts that synchronize, and extract synchronous operation commands included in the blocks;
operation state computation circuitry to compute, on a basis of the acceleration time constant and the deceleration time constant, an operation time and consumption energy that are associated with machining to be performed with the machining program;
optimum parameter computation circuitry to compute, for each of the synchronous operation commands, the acceleration time constant and the deceleration time constant that result in the operation time of the drive shaft being within an allowable operation time and the consumption energy being minimum as optimum parameters, the allowable operation time representing an allowable time for operation; and
motor control circuitry to generate a control signal for the motor on the basis of the optimum parameters.

2. The motor control device according to claim 1, wherein
after computing the optimum parameters, the optimum parameter computation circuitry computes drive shaft-specific operation start timing that results in the consumption energy being minimum during an evaluation period, the evaluation period being a maximum one of a plurality of the operation times of the plurality of the drive shafts, and
the motor control circuitry generates a control signal for the motor on a basis of the optimum parameters and the operation start timing.

3. The motor control device according to claim 2, wherein
the operation state computation circuitry computes, on the basis of the acceleration time constant and the deceleration time constant, an instantaneous power value that is to be a power value at each of time points during operation of the drive shaft and computes a total power value that is a sum of a plurality of the instantaneous power values of the plurality of the drive shafts at each of the time points, and
after computing the optimum parameters and the operation start timing, the optimum parameter computation circuitry changes at least one of the optimum parameters or the operation start timing in causing a minimum one and a maximum one of a plurality of the total power values to fall within a permissible range for the total power value and causing the consumption energy to be minimum.

4. The motor control device according to claim 3, wherein
maximum regenerative power and maximum powering power of converters to be used in controlling the motor are limits corresponding to the permissible range.

5. The motor control device according to claim 1, wherein
the optimum parameter computation circuitry generates, for each of the plurality of the drive shafts, discrete distributions having the operation time and the consumption energy that correspond to the acceleration time constant and the deceleration time constant as variables and applies surface approximation to the discrete distributions in obtaining an approximation surface expressing one of the operation time and the consumption energy as a continuous function of another of the operation time and the consumption energy that correspond to the acceleration time constant and the deceleration time constant and computing the optimum parameters on a basis of the approximation surface.

6. The motor control device according to claim 1, wherein
the plurality of the drive shafts include a spindle that is used in rotating a tool and a tool feed shaft that is used in moving the tool, and
the synchronous operation commands include commands using the spindle and the tool feed shaft for tool change of the tool.

7. The motor control device according to claim 6, wherein the blocks extracted from within the machining program by the synchronous operation command extraction circuitry include at least one of a first movement block for movement from a machining end position, where machining before the tool change ends, to a tool change position, where the tool change is performed, or a second movement block for movement from a tool change end position, where the tool change ends, to a machining start position, where machining is performed next after the tool change.

8. A machining system comprising:
the motor control device according to claim 1; and
a machining apparatus including the motor to be controlled by the motor control device.

9. A motor control method for a motor control device to generate, on a basis of an acceleration time constant that defines an acceleration time of a drive shaft and a deceleration time constant that defines a deceleration time of the drive shaft, a control signal for a motor that drives the drive shaft, the motor control method comprising:
a synchronous operation command extraction of extracting, from within a machining program, blocks where set-point control is to be continuously commanded for a plurality of the drive shafts that synchronize and extracting synchronous operation commands included in the blocks;
an operation state computation of computing, on a basis of the acceleration time constant and the deceleration time constant, an operation time and consumption energy that are associated with machining to be performed with the machining program;
an optimum parameter computation of computing, for each of the synchronous operation commands, the acceleration time constant and the deceleration time constant that result in the operation time of the drive shaft being within an allowable operation time and the consumption energy being minimum as optimum parameters, the allowable operation time representing an allowable time for operation; and
a motor control of generating a control signal for the motor on the basis of the optimum parameters.

10. A machining method for a machining system to generate, on a basis of an acceleration time constant that defines an acceleration time of a drive shaft and a deceleration time constant that defines a deceleration time of the drive shaft, a control signal for a motor that drives the drive shaft and perform machining, the machining system including a motor control device and a machining apparatus including the motor to be controlled by the motor control device, the machining method comprising:
a synchronous operation command extraction of extracting, from within a machining program, blocks where set-point control is to be continuously commanded for a plurality of the drive shafts that synchronize and extracting synchronous operation commands included in the blocks;
an operation state computation of computing, on a basis of the acceleration time constant and the deceleration time constant, an operation time and consumption energy that are associated with machining to be performed with the machining program;
an optimum parameter computation of computing, for each of the synchronous operation commands, the acceleration time constant and the deceleration time constant that result in the operation time of the drive shaft being within an allowable operation time and the consumption energy being minimum as optimum parameters, the allowable operation time representing an allowable time for operation;
a motor control of generating a control signal for the motor on the basis of the optimum parameters; and
a machining of performing the machining through operation of the motor in accordance with the control signal.
